(19) United States
(12) Patent Application Publication
(10) Pub. No.: US 2025/0091946 A1
(43) Pub. Date: Mar. 20, 2025

(54) COMPOSITION FOR KITCHEN OR BATHROOM FURNISHINGS, SUCH AS SINKS, WASHBASINS, WORKTOPS, TUBS AND SHEETS

(71) Applicant: DELTA SRL, Montecassiano (MC) (IT)

(72) Inventors: Antonio BUGIOLACCHIO, Recanati, (MC) (IT); Samuele ROSSINI, Castelfidardo (AN) (IT); Maria Savina PIANESI, Macerata (IT)

(21) Appl. No.: 18/729,243

(22) PCT Filed: Jan. 12, 2023
(86) PCT No.: PCT/IB2023/050281

§ 371 Date: Jul. 16, 2024

(30) Foreign Application Priority Data
Jan. 17, 2022 (IT) 102022000000614

(51) Int. Cl. C04B 18/165; C04B 18/167; C04B 26/06; C04B 26/18; C04B 111/00; C04B 111/54

(52) U.S. Cl. CPC C04B 18/165; C04B 18/167; C04B 26/06; C04B 26/18; C04B 2111/00965; C04B 2111/54

(57) ABSTRACT

Composition for the production of sinks including: fillers obtained from recovered material, resin obtained from recovered material, and virgin additives obtained neither from recovered materials nor from materials of animal or plant origin. The recovered fillers include one or more of the following materials: recovered glass microspheres, recovered quartz, recovered material obtained from the grinding of sinks with a base of quartz or glass fillers and resin and aluminum trihydrate (ATH). The resin is an acrylic syrup obtained from recovered material or polyester obtained from recovered material. The virgin additives include at least one cross-linking agent that favors the cross-linking of the resin and one compatibilizing substance that favors the adhesion of the resin to the fillers, where said virgin additives are in a weight percentage of less than 9% of the total weight of the composition.

The present invention relates to a composition for furnishings, particularly for kitchens or bathrooms, such as sinks, washbasins, worktops, tubs and sheets obtained from recovered or second-generation materials

A kitchen sink is generally manufactured with a composition comprising mineral fillers and a resin that provides the cohesion of the mineral fillers.

In the name of the same applicant, WO2013/017651A1 discloses a composition for kitchen sinks comprising quartz mineral fillers and an acrylic syrup resin comprising a monomer (methyl methacrylate (MMA)) and a polymer (poly-methyl methacrylate (PMMA)).

In the name of the same applicant, WO2016/177662A1 discloses a composition for kitchen sinks comprising aluminum trihydrate (ATH) mineral fillers and a polyester resin.

Such compositions of the prior art are obtained from virgin raw materials. As a result, the sinks made from such compositions have an environmental impact.

Recently, just like many other markets, the market of kitchen sinks has seen an increasing demand for “green” products, that is to say, products with a low environmental impact made from recovered and/or plant-based raw materials.

US2021/087383A1 discloses a composition that can be used for kitchen sinks. Such a composition comprises mineral fillers, an acrylic syrup, and cross-linkers. The cross-linkers consist of biomonomers of plant or animal origin. The acrylic syrup comprises a polymer of plant or animal origin or obtained from recovered materials. However, in such a case, the mineral fillers are not made of recovered materials and the monomer of the acrylic syrup is a virgin raw material, is not of plant origin and is not obtained from recovered materials. Considering that the mineral fillers have a weight percentage of approximately 50% relative to the total weight of the composition and that the monomer of the acrylic syrup has a weight percentage of approximately 20% relative to the total weight of the composition, such a composition has at least 70% of virgin material and cannot be defined as “green”.

The purpose of the present invention is to eliminate the drawbacks of the prior art by providing a composition suitable for manufacturing kitchen sinks that is obtained almost entirely from recovered material and hence has a low environmental impact and can be considered as “green”.

Another purpose is to provide such a composition that ensures an adequate cohesion between the mineral fillers and the resin.

These purposes are achieved in accordance with the present invention with the features of the attached independent claims.

Advantageous realizations of the invention appear from the dependent claims.

Hereafter, when a percentage of a component of the composition is given, said percentage indicates the weight percentage of such component relative to the weight of the final composition.

The composition according to the invention comprises:
fillers obtained from recovered material,
resin (polymers) obtained from recovered material, and
virgin additives.

The virgin additives are synthetic additives that are obtained neither from recovered materials nor from material of plant or animal origin.

The composition includes more than 91 percent recovered materials and can be considered green.

The fillers are contained in the composition in a weight percentage comprised between 50% and 90% of the total weight of the composition. The resin is contained in the composition in a weight percentage comprised between 10% and 50% relative to the total weight of the composition.

The percentages of the fillers and of the resins depend on the type of fillers and resins used.

The recovered fillers comprise one or more of the following materials:
recovered glass microspheres;
recovered quartz;
recovered material obtained from the grinding of sinks with a base of mineral fillers, comprising quartz and/or feldspar and resin;
recovered aluminum trihydrate (ATH);
recovered calcium carbonate; and
recovered glass fibers.

The recovered glass microspheres consist in spherical solid glass particles having a particle size of less than 300 μm. Advantageously, a first type of glass microspheres with particle size less than 50 μm and a second type of microspheres with particle size comprised between 63 μm and 212 μm can be used. In such a way, the smaller granules of the first type of glass microspheres are interposed between the larger granules of the second type of glass microspheres, thus obtaining a better compactness.

The glass microspheres are coated with silane (added in bulk or pre-silanized) to better adhere to the resin.

The recovered quartz has a particle size of less than 1 mm. Advantageously, a first type of quartz with a particle size of 0.1 to 0.3 mm and a second type of quartz with a particle size of 0.3 to 0.7 mm are used. In such a way, the smaller granules of the first type of quartz are interposed between the larger granules of the second type of quartz, thus obtaining a better compactness.

In order to achieve a better color uniformity of the recovered quartz, which is heterogeneous in color, advantageously the recovered quartz is coated with epoxy resin in a percentage comprised between 0.5% and 2% relative to the total weight of the recovered quartz and possibly colored with pigments of different colors (e.g., black, chrome, and white) in a percentage comprised between 0.3% and 1% relative to the total weight of the recovered quartz. The epoxy resin and the pigments are virgin materials. Therefore, the coated recovered quartz used in the composition according to the invention contains at least 97% of recovered material.

The recovered charge can be used directly at 100%, with no need for the epoxy resin coating.

The recovered material from sinks is obtained from the grinding of sinks so as to obtain particles having a particle size of less than 2 mm, preferably comprised between 0.1 and 1.5 mm. Such sink particles comprise a resin consisting of acrylic syrup and mineral fillers that may be quartz and/or feldspar and possibly glass.

In order to achieve a color uniformity of the heterogeneously colored recovered quartz contained in the composition and a better adhesion of the resin of the composition on the recovered material obtained from sinks, advantageously, the recovered material from sinks is coated with epoxy resin or polyurethane resin, in a percentage comprised between 0.5% and 2% relative to the total weight of the recovered material from sinks and possibly colored with color pigments, in a percentage comprised between 0.3% and 1% relative to the total weight of the recovered material from sinks. The epoxy resin and the pigments are virgin materials. Therefore, the recovered material obtained from sinks that is coated with resin and colored used in the composition according to the invention contains at least 97% of recovered material. Considering that the quartz or the fillers in the composition are in percentage of approximately 50%-90%, it can be affirmed that in the composition the resin coating and the pigments are in a percentage of less than 3%, or are not present.

The recovered aluminum trihydrate (ATH) has a particle size of less than 100 μm.

In order to increase the mechanical properties of the sink, the recovered fillers may also comprise recovered glass fibers in a percentage comprised between 2% and 20% relative to the total weight of the composition.

In the case where the fillers comprise recovered quartz and glass fibers, the glass fibers also serve to improve the rheology of the composition, preventing a precipitation of the recovered quartz.

In addition, in the case where the fillers comprise recovered quartz, such fillers may also comprise glass microspheres in a percentage comprised between 18% and 50% relative to the total weight of the composition. In a special case (deep black sink), the percentage of glass microspheres is between 50% and 70% relative to the total weight of the composition.

Since the recovered quartz particles do not have a perfectly rounded surface, like the quartz particles obtained as virgin raw material, such recovered quartz particles do not slide well with each other. Having a spherical surface, the glass microspheres help to improve the sliding of the recovered quartz particles. Also in such a case, a first type of glass microspheres with particle size less than 50 μm and a second type of glass microspheres with particle size between 63 μm and 212 μm can be used to achieve a better compactness and a better filling of the composition. The best ratio between the two types of glass microspheres is 1:2. In a special case (deep black sink), the best ratio between the two types of microspheres is 7:3.

The resin comprises a methacrylic syrup obtained from recovered material or polyester obtained from recovered material.

In the case where the resin is a methacrylic syrup, such a resin comprises a monomer consisting of methyl methacrylate (MMA) obtained from recovered material and may contain a polymer of poly-methyl methacrylate (PMMA) obtained from recovered material.

The virgin additives comprise at least one cross-linker that favors the cross-linking of the resin and one compatibilizing substance that favors the adhesion of the resin to the mineral fillers.

The cross-linking agent may comprise cross-linking monomers, such as one or more of the following monomers:
Ethylene glycol dimethacrylate (EGDMA),
Trimethylolpropane trimethacrylate (TMPTMA),
Bisphenol A ethoxylated dimethacrylate BPA2EODMA.

These cross-linking monomers are virgin raw materials and are present in the composition in a weight percentage comprised between 0.7% and 2.5%.

The compatibilizing substance is silane and is a virgin raw material present in the composition in a weight percentage comprised between 0.05% and 1.5% relative to the total weight of the composition.

As it can be seen, the composition has a percentage of virgin additives comprised between 3% and 5%.

The composition may optionally comprise pigments to give a coloration of the final product. In such a case the pigments are obtained from synthetic materials and cannot be natural pigments, as natural pigments cannot give an adequate long-lasting coloration for products that must withstand high temperatures. In any case, if pigments are added, the weight percentage of such pigments is less than 4%, preferably comprised between 0.1% and 4%. It must be considered that in the final composition:
the virgin additives are in a percentage of less than 3%-5%,
any synthetic pigments are in a weight percentages of less than 4%, and
the possible coating of epoxy resin and pigments of the quartz fillers or recovered material from sinks is in a weight percentage of less than 3%.

Therefore, the final composition has more than 91% of recovered materials. In any case, by properly controlling the percentages of virgin additives, synthetic pigments, and epoxy resin coating and pigments of the fillers, compositions having more than 95% recovered materials, preferably more than 98% of recovered materials, can be obtained.

Optionally, the composition may also comprise a bio-additive obtained from substances of plant or animal origin. The bio-additive is a bio-co-monomer, such as Isobornyl methacrylate and C17, which serves to raise the glass transition temperature (Tg) of the composition and to increase the resistance of the sink to high temperatures.

Additional features of the invention will appear clearer from the description of the following examples, with reference to the attached drawings, wherein:

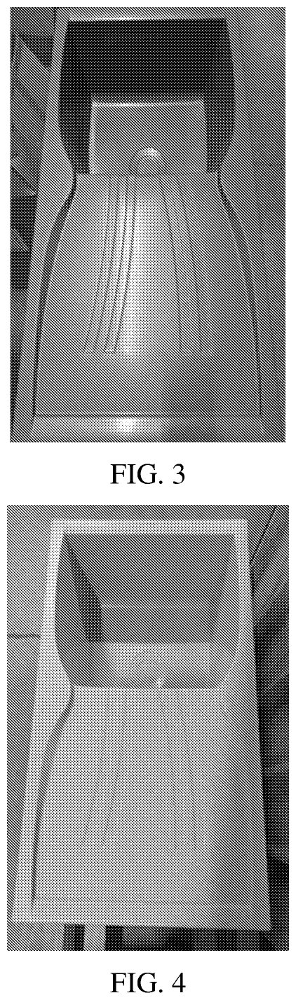

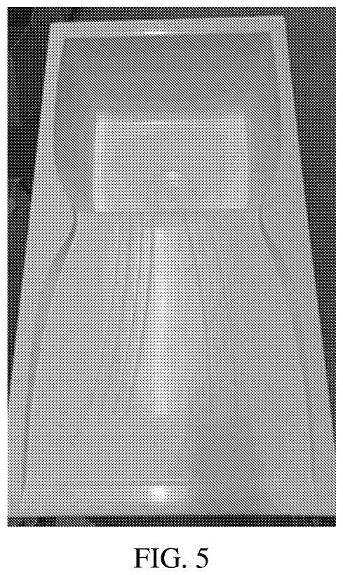

FIGS. 1 to 5 are photographs of five sinks of different colors obtained from compositions according to the invention.

Specific examples of compositions according to the invention are described below.

The prefix “r-” appended in front of a material indicates that the material is obtained from recovered material.

TABLE 1
Color: Deep Black

| RAW MATERIAL | PERCENTAGE |
|---|---|
| r-MMA | 16.6% |
| r- PMMA | 3.4% |
| EGDM | 0.4% |
| BPA2EODMA | 0.8% |
| TRIMETHOXY SILANE | 0.10% |
| Isobornyl methacrylate | 3.2% |
| r-Glass fibers | 8% |
| r-Silanized glass microspheres less than | 47.3% |
| 50 microns | |
| r-Silanized glass microspheres less than | 19.9% |
| 300 microns | |
| Black pigment | 0.3% |

The composition in Table 1 has recovered glass microspheres as fillers and an acrylic syrup as resin, and also comprises other fillers in the form of glass fibers.

The percentage of recovered microspheres is between 63% and 73%, in which 45%-50% of microspheres with particle size less than 50 μm and 18%-22% of microspheres with particle size less than 300 μm.

The percentage of glass fibers is between 6% and 10%.

The acrylic syrup comprises MMA in a percentage comprised between 15% and 18% percent and PMMA in a percentage comprised between 2.5% and 4.5%.

Such a composition has silane as a compatibilizer in a percentage comprised between 0.1% and 0.2%

In addition, such a composition may optionally comprise a Bio-co-monomer (Isobornyl methacrylate) in a percentage comprised between 3% and 3.5% and black pigments in a percentage comprised between 0.2% and 0.4%.

The composition in Table 1 has 95.2% of materials from recovered materials and 3.2% of bio-materials from materials of plant origin.

The composition using quartz as mineral filler requires that the quartz to be coated with an epoxy resin in a percentage between 0.5% and 2% relative to the total weight of the quartz. Such quartz can also be colored with pigments in a percentage between 0.5% and 1% relative to the total weight of quartz.

In the case where acrylic syrup is used as resin, in addition to quartz, the fillers comprise glass microspheres and glass fibers.

The quartz is in a percentage between 47% and 52%.

The glass microspheres are in a percentage between 18% and 22%.

The glass fibers are in a percentage between 5% and 7%.

The MMA is a percentage between 15% and 17%.

The PMMA is in a percentage between 3.5% and 5.5%.

In addition, quartz is present with different particle sizes. There is a first type of quartz with particle size between 0.1 and 0.3 mm and a second type of quartz with particle size between 0.3 and 7 mm.

For dark colors, such as black and chrome, the percentage of the first type of quartz is equal to the percentage of the second type of quartz for example both percentages are between 22% and 27%.

For light colors, such as white and beige, the percentage of the first type of quartz is less than the percentage of the second type of quartz. For example, the percentage of the first type of quartz is between 17% and 22% relative to the weight of the total composition, and the percentage of the second type of quartz is between 27% and 32% relative to the weight of the total composition.

Tables 2, 3, 4 and 5 illustrate four examples of quartz, glass microspheres, glass fibers and acrylic compositions respectively of different colors based on quartz of different colors and pigments of different colors.

TABLE 2
Color: Nanostone Black

| RAW MATERIAL | % |
|---|---|
| r-MMA | 18.5% |
| r- PMMA | 4.6% |
| EGDM | 0.6% |
| TRIMETHOXYSILANE | 0.10% |
| r-Glass fibers | 5.9% |
| r-Glass microspheres 0-50 microns | 6.9% |
| r-Glass microspheres 63-212 microns | 13.8% |
| r-Black Matt Quartz 0.1-0.3 mm | 24.7% |
| r-Black Matt Quartz 0.3-0.7 mm | 24.7% |
| Black pigment | 0.45% |

Considering that the recovered quartz has approximately 1.5% of non-recovered material due to the epoxy resin coating and to the pigments, the composition in Table 2 has more than 97% of materials from recovered materials.

TABLE 3
Color: Chrome

| RAW MATERIAL | % |
|---|---|
| r-MMA | 18.4% |
| r- PMMA | 4.7% |
| EGDM | 0.5% |
| TMPTM | 0.03% |
| TRIMETHOXY SILANE | 0.1% |
| r-Glass fibers | 5.9% |
| r-Glass microspheres 0-50 microns | 6.9% |
| r-Glass microspheres 63-212 microns | 13.8% |
| r-Chromium Quartz 0.1-0.3 mm | 24.7% |
| r-Chromium Quartz 0.3-0.7 mm | 24.7% |
| Gray pigment | 0.45% |

Likewise the composition in Table 2, the composition in Table 3 has more than 97% of materials from recovered materials.

TABLE 4
Color: Beige

| RAW MATERIALS | % |
|---|---|
| r-MMA | 17.0% |
| r- PMMA | 4.4% |
| EGDM-SR 206 | 0.6% |
| TMPTM | 0.03% |
| TRIMETHOXY SILANE | 0.10% |
| Beige Pigments | 2.0% |
| r-Glass fibers | 5.9% |
| r-Glass microspheres 0-50 microns | 6.9% |
| r-Glass microspheres 63-212 microns | 13.8% |
| r-Milk White Quartz 0.1-0.3 mm | 19.7% |
| r-Milk White Quartz 0.3-0.7 mm | 29.6% |

The composition of Table 4 has more than 95% of materials from recovered materials.

TABLE 5
Milk White

| RAW MATERIAL | % |
|---|---|
| r-MMA | 15.4% |
| r- PMMA | 4.1% |
| EGDM | 0.6% |
| TMPTM | 0.03% |
| TRIMETHOXY SILANE | 0.1% |
| r-Glass fibers | 5.9% |
| r-Glass microspheres 0-50 microns | 6.9% |
| r-Glass microspheres 63-212 microns | 13.8% |
| r-Milk White Quartz 0.1-0.3 mm | 19.7% |
| r-Milk white Quartz 0.3-0.7 mm | 29.6% |
| White Pigment | 0.45% |

The composition of Table 5 has more than 93% of materials from recovered materials.

TABLE 6
Black Matt

| RAW MATERIAL | % |
|---|---|
| r-MMA | 28.1% |
| r- PMMA | 8.9% |
| TMPTM | 1.0% |
| TRIMETHOXY SILANE | 0.1% |
| r-Black Matt Quartz 0.1-0.3 mm | 31.0% |
| r-Black Matt Quartz 0.3-0.7 mm | 31.0% |

The composition of Table 6 has more than 98% of materials from recovered materials.

To make the sinks with the compositions in Tables 1 to 5, a preparation of the totally recovered acrylic syrup was prepared by dissolving r-PMMA granules in the r-MMA liquid. For this purpose, a vertical stirrer and a heating lamp were used to maintain the temperature of the solvent at 30° C. From the results observed in previous pilot tests, substantially similar acrylic syrup formulations were used for products of Black Nanostone and Chrome color, whereas slightly different acrylic syrup formulations were used for products of Deep black, Beige and White color.

After the r-acrylic syrup was prepared, a mixture of r-glass microspheres, r-glass fibers, compatibilizing and cross-linking additives, and black pigments was added to obtain the deep black product. The dispersion was poured into a mold and molded, using peroxide initiators at high temperature, forming the sink shown in FIG. 1.

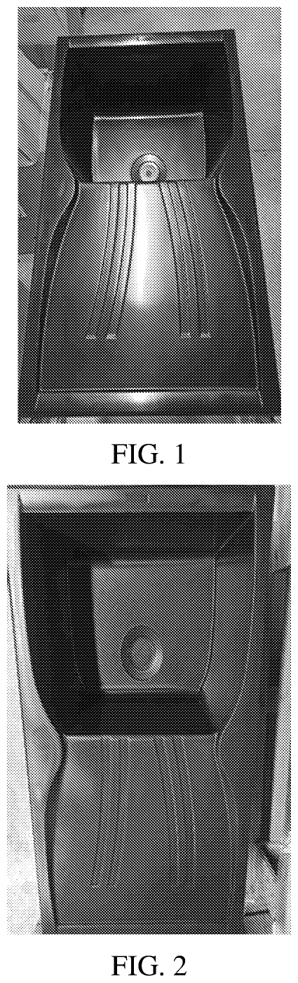

In contrast, to obtain the Nanostone Black, Chrome, Beige and White products, a mixture of r-glass microspheres, r-glass fibers, r-quartz (black, chrome and white, respectively), compatibilizing and cross-linking additives and pigments (black, chrome and white, respectively) was added to the methacrylic syrup. The dispersion was poured into a mold and molded, using peroxide initiators at high temperature, forming the sinks shown in FIGS. 2 to 5, respectively.

The composition that uses recovered material from sinks as filler requires that the recovered material is coated with an epoxy resin in a percentage comprised between 0.5% and 3% relative to the total weight of the recovered material from sinks and possibly the addition of colored pigments in a percentage of 0.5% and 1% relative to the weight of the recovered material from sinks.

In the case where the composition comprises recovered material and acrylic syrup, the recovered material is in a percentage comprised between 37% and 47%. The acrylic syrup comprises MMA in a percentage comprised between 49% and 53% and PMMA in a percentage comprised between 3% and 7%. As it can be seen, in order to achieve a good adhesion of the acrylic syrup to the sink fragments, it was necessary to increase the percentage of methacrylic syrup significantly, compared to the traditional applications with virgin raw materials.

Table 7 shows an example of a composition with recovered material from sinks and acrylic.

TABLE 7
Acrylic + waste sinks

| RAW MATERIAL | % |
|---|---|
| r-MMA | 51.2% |
| r- PMMA | 4.8% |
| EGDM | 0.5% |
| TRIMETHOXY SILANE | 0.1% |
| Ground waste sinks (0.1-0.5 mm) | 43.5% |

Considering that the recovered material from sinks contains approximately 3% of epoxy resin and pigments, and that 43.5% of recovered material is used, the composition in Table 7 has 98.1% of materials from recovered material.

TABLE 8
ACRYLIC + waste sinks + other recovered material

| RAW MATERIAL | % |
|---|---|
| r-MMA | 28.8% |
| r- PMMA | 3.0% |
| EGDM | 0.5% |
| TRIMETHOXY SILANE | 0.1% |
| r-Glass microspheres 0-50 microns | 6.9% |
| r-Glass microspheres 63-212 microns | 13.8% |
| r-Quartz 0.1-0.3 mm | 6.5% |
| r-Quartz 0.1-0.7 mm | 26.2% |
| Ground waste sinks (0.1-0.5 mm) | 15.0% |

Compared with Table 7, Table 8 has an additional recovered material comprising glass microspheres and quartz.

Polyester also showed adhesion as good as acrylic when used with recovered material from sinks. In such a case the recovered material is in a percentage comprised between 35%-45% and the polyester is in a percentage comprised between 48.5% and 58.5%.

Table 9 shows an example of a composition with recovered material from polyester sinks.

TABLE 9
POLYESTER + ground waste sinks

| RAW MATERIAL | % |
|---|---|
| r-POLYESTER | 35.6% |
| r- MMA | 5.9% |
| EGDM | 0.5% |
| TRIMETHOXY SILANE | 0.1% |
| Ground waste sinks (0.1-1 mm) | 58.0% |

Considering that the recovered material from sinks contains approximately 3% of epoxy resin and pigments, and that 40% of recovered material is used, the composition of Table 9 has 98.2% of materials from recovered material.

TABLE 10
POLYESTER + waste sinks + other recovered material

| RAW MATERIAL | % |
|---|---|
| r-polyester | 31.0% |
| EGDM | 0.5% |
| TRIMETHOXY SILANE | 0.1% |
| r-Glass microspheres 0-50 microns | 6.9% |
| r-Glass microspheres 63-212 microns | 13.8% |
| r-Quartz 0.1-0.3 mm | 6.5% |
| r-Quartz 0.1-0.7 mm | 26.2% |
| Ground waste sinks (0.1-0.5 mm) | 15.0% |

Compared with Table 9, Table 10 has an additional recovered material comprising glass microspheres and quartz.

In the case of using as recovered ATH as filler, the percentage of recovered ATH is between 34% and 44% regardless of whether polyester or acrylic syrup is used as resin. Hence, if polyester is used as resin, the percentage of polyester is between 48.5% and 58.5%. If methacrylic syrup is used, the percentage of MMA is between 45% and 55% and the percentage of PMMA is between 11% and 15%. Such a composition does not require the use of other fillers or pigments.

Table 11 shows an example of composition with ATH and acrylic.

TABLE 11
Acrylic + ATH

| RAW MATERIAL | % |
|---|---|
| r- MMA | 32.4% |
| r- PMMA | 7.0% |
| EGDM | 0.5% |
| TRIMETHOXY SILANE | 0.1% |
| r-ATH | 60% |

The composition of Table 11 has 99.4% of materials from recovered materials.

Table 12 shows an example of composition with ATH and polyester.

TABLE 12
POLYESTER + ATH

| RAW MATERIAL | % |
|---|---|
| r- POLYESTER | 33.5% |
| r- MMA | 5.9% |
| EGDM | 0.5% |
| TRIMETHOXY SILANE | 0.1% |
| r-ATH | 60.0% |

The composition of Table 12 has 99.4% of materials from recovered materials.

It is possible to make a composition that includes recovered quartz fillers and recovered polyester as resin. In such a case, the filler is in a percentage comprised between 57% and 67% and the polyester is in a percentage comprised between 33% and 43%.

Table 13 shows an example of a quartz and polyester composition.

TABLE 13
POLYESTER + QUARTZ

| RAW MATERIAL | % |
|---|---|
| r- POLYESTER | 34.4% |
| EGDM | 0.5% |
| TRIMETHOXY SILANE | 0.1% |
| r-Black Quartz 0.1-0.3 mm | 19.5% |
| r-Black Quartz 0.3-0.7 mm | 45.5% |

Considering that the recovered quartz contains approximately 3% of epoxy resin and pigments, and that 65% of recovered quartz is used, the composition in Table 13 has 97.45% of materials from recovered material.

1. Composition for kitchen or bathroom furnishings comprising:
fillers obtained from recovered material,
resin obtained from recovered material, and
virgin additives that are obtained neither from recovered materials nor from materials of animal or plant origin;
wherein the recovered fillers comprise one or more of the following materials:
recovered glass microspheres consisting in solid spherical glass particles having a particle size of less than 300 m,
recovered quartz having a particle size of less than 1.5 mm,
recovered material obtained from the grinding of sinks comprising quartz and/or feldspar and resin; said recovered material obtained from the grinding of sinks consisting of particles having a particle size of less than 2 mm, and
recovered aluminum trihydrate (ATH) having a particle size less than 100 m;
the resin comprises an acrylic syrup obtained from recovered material or polyester obtained from recovered material,
the virgin additives comprise at least one cross-linking agent that favors the cross-linking of the resin and one compatibilizing substance that favors the adhesion of the resin to the fillers;
wherein said composition comprises more than 91% in weight percentage of recovered material.

2. The composition according to claim 1, also comprising recovered glass fibers in a weight percentage comprised between 4% and 20% relative to the total weight of the composition.

3. The composition according to claim 1, also comprising color pigments in a weight percentage comprised between 0.1% and 4% relative to the total weight of the composition.

4. The composition according to claim 1, also comprising a bio-additive obtained from substances of plant or animal origin, comprising a bio-comonomer for increasing the glass transition temperature of the composition, in a weight percentage comprised between 0.5% and 5% relative to the total weight of the composition.

5. The composition according to claim 1, wherein said compatibilizing substance is silane in a weight percentage comprised between 0.08% and 2% relative to the total weight of the composition.

6. The composition according to claim 1, wherein said fillers comprise recovered glass microspheres comprising a first type of glass microspheres having a particle size of less than 50 μm and a second type of microspheres having a particle size of less than 300 μm.

7. The composition according to claim 1, comprising the following materials in a weight percentage relative to the total weight of the composition:
recovered glass microspheres in a weight percentage comprised between 63% and 73%,
recovered glass fibers in a weight percentage comprised between 4% and 20%, and
an acrylic syrup comprising meta-methyl methacrylate (MMA) obtained from recovered material and poly-methyl methacrylate (PMMA) obtained from recovered material, wherein the MMA is in a weight percentage comprised between 15% and 25% and the PMMA is in a weight percentage comprised between 0% and 5% relative to the total weight of the composition.

8. The composition according to claim 1, wherein said fillers comprise recovered quartz comprising a first type of quartz having a particle size of 0.1-0.3 mm and a second type of quartz having a particle size of 0.3-0.7 mm.

9. The composition according to claim 1, wherein said fillers comprise recovered quartz with epoxy resin coating in a weight percentage comprised between 0.5% and 3% relative to the total weight of the recovered quartz.

10. The composition according to claim 9, wherein said recovered quartz with epoxy resin coating is colored with color pigments in a weight percentage comprised between 0.3% and 1% relative to the total weight of the recovered quartz.

11. The composition according to claim 1, comprising the following materials in weight percentage relative to the total weight of the composition:
recovered quartz in a weight percentage comprised between 40% and 70%,
recovered glass microspheres in a weight percentage comprised between 10% and 70%,
recovered glass fibers in a weight percentage comprised between 4% and 20%,
MMA in a weight percentage comprised between 15% and 25%, and
PMMA in a weight percentage comprised between 1% and 5%.

12. The composition according to claim 1, wherein said fillers comprise recovered material from sinks with epoxy resin coating in a weight percentage comprised between 0.5% and 3% relative to the total weight of the recovered material from sinks.

13. The composition according to claim 12, wherein said recovered material from sinks with epoxy resin coating is colored with color pigments in a weight percentage comprised between 0.3% and 1% relative to the total weight of the recovered material from sinks.

14. The composition according to claim 1, comprising the following materials in a weight percentage relative to the total weight of the composition:
recovered material from sinks in a weight percentage comprised between 35% and 45%;
recovered MMA in a weight percentage comprised between 49% and 53%; and
recovered PMMA in a weight percentage comprised between 4% and 8%.

15. The composition according to claim 1, comprising the following materials in weight percentage relative to the total weight of the composition:
recovered material from sinks in a weight percentage comprised between 35% and 45%, and
polyester in a weight percentage comprised between 48% and 58%.

16. The composition according to claim 1, comprising the following materials in weight percentage relative to the total weight of the composition:
mineral filler consisting in recovered ATH in a weight percentage comprised between 32% and 42%,
recovered MMA in a weight percentage comprised between 45% and 55%, and
recovered PMMA in a weight percentage comprised between 4% and 8%.

17. The composition according to claim 1, comprising the following materials in weight percentage relative to the total weight of the composition:
mineral filler consisting in recovered ATH in a weight percentage comprised between 35% and 45%, and
recovered polyester in a weight percentage comprised between 48% and 58%.

18. The composition according to claim 1, comprising the following materials in weight percentage relative to the total weight of the composition:
recovered quartz in a weight percentage comprised between 57% and 67%, and
recovered polyester in a weight percentage comprised between 30% and 40%.
